(19) United States
(12) Patent Application Publication
(10) Pub. No.: US 2024/0192453 A1
(43) Pub. Date: Jun. 13, 2024

(54) PHOTONIC INTEGRATED CIRCUIT PACKAGE SUBSTRATE WITH VERTICAL OPTICAL COUPLERS

(71) Applicant: Intel Corporation, Santa Clara, CA (US)

(72) Inventors: Changhua Liu, Chandler, AZ (US); Robert A. May, Chandler, AZ (US); Bai Nie, Chandler, AZ (US)

(73) Assignee: Intel Corporation, Santa Clara, CA (US)

(21) Appl. No.: 18/078,871

(22) Filed: Dec. 9, 2022

(51) Int. Cl. G02B 6/42

(52) U.S. Cl. CPC G02B 6/4214

(57) ABSTRACT

An integrated circuit (IC) package substrate comprises an upper surface, a lower surface opposite the upper surface, and an outer side surface extending between the upper surface and the lower surface. At least one optical path is in a plane of the IC package substrate, and at least one vertical optical coupler at an upper or lower surface of the IC package substrate is optically coupled to the optical path.

### BACKGROUND

An electronic integrated circuit (IC) is a set of electronic circuits often in a die or chip comprised of a semiconductor material, e.g., silicon. An electronic IC includes electrical devices, such as transistors, metal interconnects, and electrical insulators. A photonic integrated circuit (PIC) is similar to an electronic IC except that it includes a set of photonic devices or elements in a die or chip. Photonic is meant herein in a general sense to refer to generation, transmission, detection, and/or manipulation of light.

An IC package or other assembly may include multiple electronic ICs, such as processor, logic, or memory circuit ICs, and may be electrically and physically connected to a printed circuit board (PCB) or other host carrier. In addition, a photonic IC package may include one or more PICs interconnected with the electronic ICs.

For some known photonic IC packages, a glass package substrate can be arranged to attach to a pluggable fiber array unit (FAU) that provides or receives fiber optic transmissions on a side or edge of the package substrate so that the bottom of the substrate still can be used as a land side to mount the package on a PCB or host carrier, and the top of the substrate still can be used as an active side to support and communicate with other electronic circuits, dies, chips, and/or devices. The PIC may be mounted on the substrate or may be embedded within the glass of the substrate.

The horizontal fiber optic connection between the FAU and the side of the substrate often requires very high precision, however, which is extremely difficult to achieve, and in turn expensive, due to the manufacturing processes and manufacturing tolerances.

### BRIEF DESCRIPTION OF THE DRAWINGS

The subject matter described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a cross-sectional side view of an example photonic integrated circuit (IC) package and a fiber array unit (FAU) mounted on the package according to at least one of the implementations described herein;

FIG. 2A is a cross-sectional side view of an example vertical optical coupler assembly at an optical connection between an FAU and a package substrate according to at least one of the implementations described herein;

FIG. 2B is a cross-sectional side view of the example vertical optical coupler assembly of FIG. 2A shown with optical rays according to at least one of the implementations described herein;

FIG. 3A is a cross-sectional side view of another example vertical optical coupler assembly on an optical connection between an FAU and a package substrate according to at least one of the implementations described herein;

FIG. 3B is a cross-sectional side view of the example vertical optical coupler assembly of FIG. 2A shown with optical rays according to at least one of the implementations described herein;

FIG. 4 is a cross-sectional side view of an alternative example vertical optical coupler assembly on an optical connection between an FAU and a package substrate according to at least one of the implementations described herein;

FIG. 5 is a plan view of an example photonic package substrate according to at least one of the implementations described herein;

FIG. 6 is a flow chart illustrating an example method of forming a vertical optical coupler assembly on a photonic IC package substrate according to at least one of the implementations described herein;

FIGS. 7A-7D are example cross-sectional side views of photonic IC package substrate manufacturing stages according to at least one of the implementations described herein;

FIG. 8 is a functional block diagram of an electronic computing device including a photonic IC package substrate in accordance with various implementations; and

FIG. 9 illustrates a mobile computing platform and a data server machine employing a photonic IC package substrate in accordance with various implementations.

### DETAILED DESCRIPTION

Implementations discussed herein variously provide techniques and mechanisms for optically coupling light transmission structures of a photonic package substrate to optical fibers of a fiber array unit (FAU). The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including vertical optical coupling between a photonic package substrate and an FAU.

Implementations are described with reference to the enclosed figures. While specific configurations and arrangements are depicted and discussed in detail, it should be understood that this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary implementations. Further, it is to be understood that other implementations may be utilized and structural and/or functional changes may be made without departing from the scope of claimed subject matter. It should also be noted that directions and references (e.g., up, down, top, bottom, etc.) may be used merely to facilitate the description of features in the drawings and relationship between the features. Therefore, the following detailed description is not to be taken in a limiting sense and the scope of claimed subject matter is defined solely by the appended claims and their equivalents.

In the following description, numerous details are set forth. However, it will be apparent to one skilled in the art, that implementations may be practiced without these specific details. In some instances, well-known methods and devices are shown in block diagram form, rather than in detail, to avoid obscuring the implementations.

Reference throughout this specification to “an implementation” or “one implementation” or “some implementations” means that a particular feature, structure, function, or characteristic described in connection with the implementation is included in at least one implementation. Thus, the appearances of the phrase “in an implementation” or “in one implementation” or “some implementations” in various places throughout this specification are not necessarily referring to the same implementation. Furthermore, the particular features, structures, functions, or characteristics may be combined in any suitable manner in one or more implementations. For example, a first implementation may be combined with a second implementation anywhere the particular features, structures, functions, or characteristics associated with each of the two implementations are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. It should be understood that these terms are not intended as synonyms for each other. Rather, in particular implementations, “connected” may be used to indicate that two or more elements are in direct physical, optical, and/or electrical contact with each other. “Coupled” may be used to indicated that two or more elements are in either direct or indirect (with other intervening elements between them) physical, optical, or electrical contact with each other, and/or that the two or more elements co-operate or interact with each other (e.g., as in a cause an effect relationship).

The terms “over,” “under,” “between,” and “on” as used herein refer to a relative position of one component or material with respect to other components or materials where such physical relationships are noteworthy. For example, in the context of materials, one material or structure disposed over or under another may be directly in contact or may have one or more intervening materials. Moreover, one material disposed between two materials may be directly in contact with the two materials or may have one or more intervening materials. In contrast, a first material or structure “on” a second material or structure is in direct contact with that second material/structure. Similar distinctions are to be made in the context of component assemblies where a first component may be “on” or “over” a second component.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

A photonic integrated circuit package substrate with vertical optical couplers is described herein.

The coupling between waveguide or fiber optic cable terminating at a side or edge of a photonic package substrate and an end of fiber optic cable on an FAU often must be very precise in order to provide high quality fiber optic signal transmission, such as within a maximum misalignment (or manufacturing tolerance) up to 1-2 μm. For single mode fiber. During the manufacturing process, however, singulation separation of package substrates from a glass substrate wafer may bend or damage the sides or edges of the substrates enough to cause optical miscommunication or inefficiencies.

Also, pluggable FAUs may be mounted by tight-fit or snap-fit to a side or edge of the package substrate rather than glue, solder, or other more permanent forms of adhesion because the use of pluggable FAUs can significantly increase yield compared to the yield of the adhered FAUs. Specifically, when a permanent adhesion FAU has a single component failure on the FAU, or a single adhesion failure (e.g. due to alignment issues), this results in a total unit failure for the package. Instead, a pluggable FAU can simply be replaced rather than the entire package unit when the FAU is faulty. A pluggable FAU also has a wider alignment tolerance than a permanently adhered FAU.

The plugging operation itself, however, still can result in mechanical misalignment that cannot be corrected due to limitations of the manufacturing tolerances of the size or shape of the components and/or mechanical misalignment errors caused by the FAU mounting tools.

Conventionally, in order to attempt to reduce the alignment precision needed for an adequate fiber optic connection, a substrate edge lens bump and socket connection that widens the optical beam at the connection is known to be used between the FAU and side of the substrate rather than a simple mode fiber alignment. In this case, the widening of the beam at the edge connection reduces the criticality of precise alignment between the optics on the FAU and the substrate. This arrangement, however, raises the cost of each fiber connection significantly because of the required precision. Specifically, expensive equipment and alignment operations must be used so that laser or waveguide facets on the edge of the substrate need to be made optically smooth and perfectly perpendicular to the edge laser optical path or inadequate alignment will result.

As another alternative, the FAU may have a matrix of these fiber connectors (without expanding the beams) at the substrate edge and that branch outward from a single originating fiber on the FAU. The use of a matrix instead of only a single connection increases the likelihood that more channels and higher bandwidth will be transmitted even when misalignments are present. This alternative, however, creates further unnecessary bending loss thereby decreasing the light energy that can be used for transmissions.

To resolve these issues, an integrated circuit (IC) photonic package substrate has at least one vertical optical coupler assembly to redirect or divert light from horizontal optical paths or waveguides on the substrate and into a vertical optical path or path portion so that vertical optical coupling can be established between the FAU and the substrate at an upper or lower surface of the substrate rather than at an edge or side of the substrate. This can be accomplished by using one or more mirrors within the substrate and a vertical optical coupler at the upper or lower surface of the substrate.

It should be noted that vertical and horizontal are meant at least in a general sense to refer to mostly vertical or mostly horizontal (e.g., where vertical refers to closer than 45 degrees to exactly vertical (0 degrees), and horizontal refers to closer than 45 degrees to exactly horizontal (90 degrees)). By another form, unless context restricts it otherwise, vertical refers to an optical or light path having a vertical component or portion so that light will intersect an upper (or top) or lower (or bottom) surface of the package substrate.

By one specific example, a device may have an integrated circuit (IC) package substrate with an upper surface, a lower surface opposite the upper surface, and an outer side surface or edge extending between the upper surface and the lower surface. At least one optical path is in a plane of the IC package substrate. In other words, the optical path is horizontal, or at least generally, nearly, or substantially horizontal, when the package is stacked vertically, and is in the plane or level of the substrate.

By one form, at least one vertical optical coupler at an upper or lower surface of the IC package substrate is optically coupled to the optical path. This is accomplished by using one or more mirrors within the substrate to redirect light from the optical path to a vertical optical path or portion and toward an upper or lower surface of the substrate or vice-versa (where light from the vertical optical path portion is redirected by the mirror to the optical path in the plane of the substrate).

In more detail, the optical path has at least one portion extending toward the outer side surface or edge of the substrate between the substrate's upper and lower surfaces. In some forms, the substrate is formed of a bulk glass material and no need exists for waveguides to control the optical path. In this case, the optical source or optical port, such as on a PIC for example, may define a linear optical axis for the optical path, at least for part of the optical path. Otherwise, a waveguide may be used to form each or individual optical paths on the substrate.

Light along the optical path extending toward the substrate edge may be redirected to or from at least one vertical optical coupler at an upper or lower surface of the IC package substrate. An array of the vertical optical couplers may be present on the upper or lower surface or both. The array may have any desired arrangement whether staggered, in rows or columns, and so forth. The vertical optical couplers each may be optically coupled to a different optical path on the substrate. The vertical optical couplers also may have a number of different structures. By another approach, a transparent or translucent filler within a cavity or chamber adjacent the mirror may form a flat surface at the upper or lower surface of the substrate as the vertical optical coupler of the substrate. By one form, an individual vertical optical coupler is simply a hole in the glass or other material forming the upper or lower surface of the substrate. By other forms, a convex lens forms the vertical optical coupler on the upper or lower surface of the substrate. Such a lens may or may not be integrally formed with the glass of the substrate. By other forms, a flat glass plate covers (or more precisely fills) a hole on the upper or lower surface of the substrate.

By another example, the vertical optical coupler assembly may redirect light from or to the optical path by using at least one mirror within the substrate and disposed transversely to the horizontal optical path or optical axis of the optical path (or plane of the substrate). The mirror may be positioned to intersect the optical axis or path so that light from the optical path is reflected upward or downward (or both with multiple mirrors) and toward the upper or lower surface of the substrate, and in turn the vertical optical couplers at the upper or lower surface, rather than toward the side edge of the substrate. The mirror may be planar, formed of glass, and at an oblique angle to the optical path and axis. Otherwise, the mirror maybe curved and positioned within the substrate between the optical path and the side edge to provide a same or similar reflecting effect. In either case, the mirror can be integrally formed with the glass of the substrate. This may include providing a chamber or cavity of a different material adjacent the mirror and either behind or in front of the mirror. By one form, the chamber is merely an empty cavity filled with air. By one form, the mirror may have a reflective surface, film, or layer of silver or other reflective metal or metal alloy. Thus, by one example, when the substance or material (such as air or other filler) in the cavity has a lower index of refraction than that of the substrate glass forming the mirror, and the cavity is in front of the mirror to receive incident light rays toward the mirror, then the reflective layer may be used to ensure sufficient reflection. Particularly, when the reflective layer or surface is used, the index of refraction of a material or substance in the cavity in front of the mirror is not limited and may even have an index of refraction higher than that of the substrate glass. However, when the cavity is behind the mirror so that the mirror receives incident light rays through the substrate glass that has a greater index of refraction than the substance or material in the cavity behind the mirror, the mirror then can provide sufficient reflected light without the use of the reflective layer. Many other arrangements are described below.

By yet another example, the integrated circuit (IC) package substrate may have a recess and a photonic integrated circuit (PIC) within the recess and having an optical source or optical port such that the optical path ends or starts within the substrate. Thus, at least one optical path extends from the optical port or optical source. At least one vertical optical coupler may be provided optically coupled to the optical port or optical source along the optical path. Otherwise, a light path, of which the mentioned optical path is a part, simply may be crossing through the substrate such that both the start and end of the light path are remote from the substrate.

In any of these examples, a fiber array unit (FAU) may be optically coupled to the substrate at the upper or lower surface of the substrate. The FAU may have its own vertical optical couplers each aligned with a vertical optical coupler on the substrate's upper or lower surface. The FAU vertical optical coupler also may have similar structures as that on the substrate's vertical optical couplers.

The disclosed structures with redirecting mirrors and/or vertical optical couplers on the upper or lower surfaces of the substrate may eliminate the need to maintain a high quality substrate edge. Thus, this may significantly reduce the complexity of the singulation process and increases the manufacturing tolerance ranges for the substrate edges, thereby reducing cost of the manufacturing of the package. These disclosed structures also permit making of the vertical optical couplers on the upper or lower surface of the substrate using manufacturing techniques typical of placing stacked layers on an IC package, and particularly by using the same laser-directed writing processes usually used to form optical elements on a glass substrate. Now upper or lower substrate surface vertical optical couplers can be manufactured without introducing significant additional complexity.

In addition, the upper and lower surfaces of the substrate provide sufficient area relative to the substrate dimensions for many different 2D vertical optical coupler array or matrix arrangements and sizes to achieve very high fiber or channel densities as desired. Thus, the disclosed structure is very adaptable by avoiding the relatively much smaller area of the edge of the substrate.

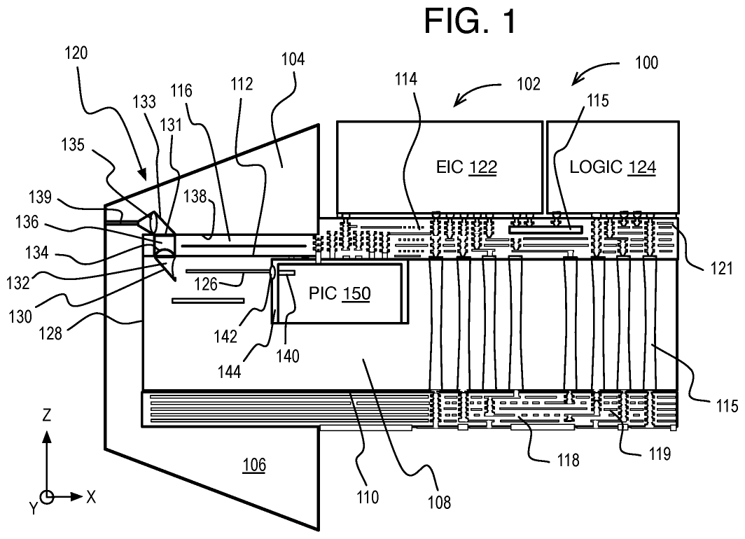

Referring to FIG. 1 for more details, a photonic IC package assembly 100 may be, or may be included in, a personal or server computer, a mobile computing platform or portable computing device arranged for one, multiple, or each of electronic data display, electronic data processing, wireless electronic data transmission, or the like. No limit exists as to the device that may have the disclosed package structure. For example, assembly 100 may be, or may be included in, a tablet, a smart phone, or laptop computer, and may include a display screen, a chip-level or package-level integrated system, and a battery. By one form, photonic IC package assembly 100 uses or is attached to fiber optic cable to transmit data or signals.

The photonic IC package assembly 100 comprises an example package 102 and a fiber array unit (FAU) 104 mounted on the package 102 and optically coupled to the package 102. Specifically, the FAU 104 is optically coupled to a package substrate 108, and optionally a photonic IC (PIC) 150 on the substrate 108. Particularly, the FAU 104 has a socket-forming clamp 106 (also referred to as just a socket) to mount the FAU 104 onto the package 102. By one form, the FAU is a pluggable FAU such that a tight-fit, snap-fit, or other known non-adhesive connection may be used between the FAU and the package 102, the details of which need not be described herein for understanding of the disclosed systems, devices, and methods. Alternatively, the FAU 104 could be non-pluggable and may be mounted by the use of adhesives, welding, or other permanent connection techniques. A vertical optical coupler assembly 120 provides vertical optical coupling between the FAU 104 and package 102 as described below. It should be noted that assembly 120 is enlarged on FIG. 1 for clarity.

The package 102 has the package substrate 108 with a lower or bottom surface (or backside or reverse or land side) 110 supporting one or more dielectric layers (or just dielectrics) 118 with embedded metallization 119, and an upper or top surface (or frontside or active side) 112 that supports dielectric layers (or dielectrics) 114 and 116 also with embedded metallization 121. Electrical, data, and/or optical vias 115 may extend through the substrate 108 and between the dielectrics 114 and 118 for example. In this example, the upper or active side dielectrics 114 and 116 may support other active or passive circuits, IC chips, semiconductor or other dies, and/or other devices. By the example shown, the dielectric layer 116 supports an electronic IC die or device 122 that has circuitry to control the PIC or die 150 embedded in the substrate 108, and a logic unit or die 124 that may have circuitry to perform specific operations or functions as desired. Also in this example, the bottom dielectric layer 118 may be arranged to bond the package 102 to a circuit board or host device, such as a printed circuit board (PCB) or mother board, for example. The phrase an integrated circuit (IC) die, as used herein, may refer to either, or both, an electronic IC and a PIC.

It will be appreciated that alternatively, the substrate 108 may only have dielectric layers on one side 110 or 112 of the substrate. By one option, dielectric 116 may be shortened to provide direct substrate 108 to FAU 104 contact rather having a hole 132 through the dielectric 116 as shown and that may be part of the vertical optical coupler assembly 120. By one form, the glass substrate 108 may have exposed glass with grooves to engage the FAU 104. Near an area of the vertical optical coupler assemblies 120. Many different arrangements for the substrate 108 may be used and is not limited to the arrangement shown on package 102.

By some forms as mentioned, substrate 108 may be a photonic substrate. The substrate 108 may comprise various types of transparent or translucent material, including fused silicon, borosilicate glass, or other glass materials such as transparent polymers. When the substrate is not transparent it may include silicon with copper planes, or other known dielectrics with fillers. In various implementations, substrate 102 comprises a patterned glass. By one form, the bulk material of the substrate 108 between the upper dielectrics 114 and 116 on one side and lower dielectric 118 on the other side may be referred to as a substrate core if the dielectric layers 114, 116, and 118 are to be considered a part of the substrate 108. When the dielectrics 114, 116, and 118 of the substrate 108 form two opposite dielectric stacks on the two opposite sides 110 and 112 of the substrate 108, the substrate 108 also may be referred to as being a substrate layer or base layer, center board, or middle layer in addition to a core, and where the layers are stacked outward from the core or base layer and in opposite directions on the two sides. While the frontside 112 may indicate an active side to be interconnected to one or more dies and the backside may be a land-side that attaches to a circuit board or other host, this may not always be the case, and the reverse could be used. For clarity of explanation only, the substrate 108 will be considered separate from its dielectric layers 114, 116, and 118 herein.

By one example approach, when the substrate 108 is formed of a glass material, the glass may be at least sufficiently transparent or translucent so that optical or light paths through the substrate can be established for fiber optic signal transmission without always using waveguides within or on the substrate. In this case, at least one or some of the light or optical paths, or portions thereof, within the substrate 108 can be established to project or propagate light through the bulk glass or other transparent or translucent material of the substrate 108. By other alternative forms, the substrate, or substrate core, is not always sufficiently transparent or translucent, and waveguides and other optical transmission components are embedded in the substrate to establish the light or optical pathways. It should be noted that the terms optical, optic, and light are used interchangeably herein to generally refer to something relating to light, and the terms path and pathway are used interchangeably as well.

The dielectric layers 114, 116, and 118 may include embedded metallization, electrical conductors, and/or conductive features including traces, pads, vias, and so forth. The dielectric layers 114, 116, and 118 may be formed of a material such as Ajinomoto build-up film (ABF), organic polymer, ceramics, optical glass, and/or inorganic filler composite, while the conductors may be made of copper, other conductive metal, and/or metal alloy, by one example. Adhesion layers between dielectric and metallization may be used as well. In one example, when the dielectric is an organic layer, the organic layer may be formed of a molded resin (e.g., an epoxy resin), ceramic composite, composite organic films comprising or consisting of silica fillers embedded in an organic polymer, liquid crystal polymer, bismaleimide triazine resin, glass-reinforced epoxy laminate material frame retardant-4 (FR4), polyimide materials, and the like.

It will be appreciated that the components within the dielectrics or supported by the dielectrics may be used for higher computational performance in smaller packages for use in various electronic products, such as computer servers, portable computers, electronic tablets, desktop computers, and mobile communication handsets, often now include one or more microelectronic packages that contain various combinations of semiconductor tiles, chips, chiplets, and dies that are integrated into one functional unit. These composite, or heterogeneous, IC device structures may include tiles, chips, chiplets, or dies created using diverse technologies and materials. The tiles, chips, chiplets, or dies may be stacked vertically, placed horizontally, or both. Connections between different devices may employ a variety of technologies, including direct bonding. Chiplets, rather than monolithic dies, disaggregate the circuits. The chiplets are electrically coupled by interconnect bridges. The term “chiplet” is used herein to refer to a die that is part of an assembly of interconnected dies forming a complete IC in terms of application and/or functionality, such as a memory chip, microprocessor, microcontroller, commodity IC (e.g., chip used for repetitive processing routines, simlogicple tasks, application specific IC, etc.), and system-on-a-chip (SoC). In other words, the chiplets are individual dies (or IC dies) connected together to create the functionalities of a monolithic IC. By using separate chiplets, each individual chiplet can be designed and manufactured optimally for a particular functionality. For example, a processor core that contains logic circuits might aim for performance, and thus might require a very speed-optimized layout. This has different manufacturing requirements compared to a USB controller, which is built to meet certain USB standards, rather than for processing speed. Thus, by having different parts of the overall design separated into different chiplets, each one optimized in terms of design and manufacturing, the overall yield and cost of the combined chiplet solution may be improved.

The connectivity between these chiplets is achievable by many different ways. For example, in 2.5D packaging solutions, a silicon interposer and Through Silicon Vias (TSVs) connect dies at silicon interconnect speed in a minimal footprint. In another example, called Embedded Multi-Die Interconnect Bridge (EMIB), a silicon bridge embedded under the edges of two interconnecting dies facilitates electrical coupling between them. Such an example EMIB chiplet 115 is shown on dielectric 114. Otherwise, in a three-dimensional (3D) architecture, the chiplets may be stacked one above the other, creating a smaller footprint overall. Typically, the electrical connectivity and mechanical coupling in such 3D architecture is achieved using TSVs and high pitch solder-based bumps (e.g., C2 interconnections). The EMIB and the 3D stacked architecture may also be combined using an omni-directional interconnect (ODI), which allows for top-packaged chips to communicate with other chips horizontally using EMIB and vertically, using Through Mold Vias (TMVs) which are typically larger than TSVs.

In some implementations that use chiplets, a composite chip may have a fill dielectric layer over BEOL a metallization stack. A fill dielectric layer may fully surround chiplet sidewalls, embedding a chiplet within dielectric material. A fill dielectric may stabilize and strengthen the composite die structure 100, and/or provide a platform for higher BEOL metallization layers. In some implementations, a fill dielectric layer comprises an inorganic dielectric material, such as, but not limited to, amorphous and polycrystalline silicon oxides, in some cases having a higher k than ILD materials. In some other implementations, a fill dielectric layer comprises an organic material, such as, but not limited to, epoxy resins and epoxy resin composites. Vias may extend through a fill dielectric layer. Vias may also interconnect upper BEOL metallization levels or embedded devices to a level M4 and lower metallization levels. Vias may route power and/or signals to a device layer for example. The IC dies discussed anywhere herein can be chiplets.

Returning to the PIC 150, the PIC 150 may be or have one or more dies or chiplets, and may be comprised of silicon or various other materials. The PIC 150 may include various optical components, such as waveguides, optical amplifiers, optical modulators, filters, optical components 140 such as optical ports for receiving light along an optical path 126 in the substrate 108 or optical sources such as lasers that emit light along the optical path 126 in the substrate 108, and optical detectors. The PIC 150 also may include electrical devices or elements in addition to optical components. Such lasers used for optical transmissions may emit infrared or light of many other wavelengths, which may or may not be with a constant wavelength and phase.

The PIC 150 also may be positioned within a cavity of the substrate 108 that has a transparent or translucent filler material 144 to hold the PIC 150. This PIC filler material 144 may be index matching material such as infrared, ultraviolet (UV), and/or thermal curable optical material with a refractive index that may or may not match that of the substrate. Thus, a good anti-reflection coating between interfaces of different refractive index materials forming the material 144 and substrate may still function adequately, even an air gap exists between the substrate and the PIC 150. In various implementations, index matching material 144 may be an ester, acrylic, or epoxy. In implementations, index matching material 144 is applied in a way so as to prevent any air gaps between where the optical signal is output or detected and substrate 108.

The PIC 150 may have more than one of the optical paths 126, and each may be defined, at least partially, by a waveguide extending from the PIC 150. The optical path 126 may or may not be completely linear, and may have at least one portion extending toward a side or edge 128 of the substrate 108. By some examples, the PIC 150 may have a number of transmission components 140 that each may be light sources (or lasers) to emit light to a different optical path 126 or optical ports to receive light from an optical path 126, or some combination of the two. By one example, the PIC 150 may have 16 or 24 transmission components 140 and in turn 16 or 24 optical paths (or waveguides) 126, although some other number of the components could be used. By one example, the optical paths 126 are at least initially linear and parallel near the PIC 150.

In the present example, multiple optical paths or waveguides 126 may be arrayed in the width of the substrate 108 (or in the Y-axis direction, or in and out of the paper on FIG. 1). A lens, collimator, or other optical element 142 may be provided at an end of the optical path (or wave guide) 126 near the PIC 150 in order to expand. Contract, or collimate (e.g., control the beam size of) the light beam of the optical path 126 and in front of the component 140 for increased accuracy. By one example form, the approximate optical diameter of the waveguide 126 (and similar to a fiber optic cable) may be in a range of about 10 to 125 microns. When no waveguide is being used, this same range may be the effective diameter of the optical path.

In any of these cases, it also will be understood that the substrate 108 may be considered to generally form a level or plane, which may be a horizontal plane, on the assembly 100, and the assembly 100 may have many different planes for dielectrics, metallization, dies, chips, devices, and so forth. In this case, the optical path 126 may be considered to be in the plane of the substrate 108, and this is described in greater detail below.

In order to provide optical coupling between the FAU 104 and the package 102 at an upper surface 112 or lower surface 110 of the substrate 108 rather than the side or edge 128 of the substrate 108, at least one vertical optical coupler assembly 120 may be used. The coupler assembly 120 may have a redirecting element 130 such as a mirror between the edge 128 and an end of the optical path or waveguide 126. When the mirror 130 is integrally formed of the glass of the substrate 108, a chamber 132 may be provided adjacent the mirror 130 in order to generate a change in the index of refraction at the mirror to better ensure reflection of light from or to the optical path 126. The mirror 130 may reflect light to vertical or into a vertical optical path or path portion to exit or enter the upper surface 112 as shown, but could alternatively be the lower surface 110. Such a vertical optical path portion may be projected through a vertical optical coupler 134, shown here as a collimator in the convex shape of a bump but other shapes may be used for the vertical optical coupler 134. For example, the vertical optical coupler 134 may be a collimator, lens, flat glass plate, flat exposed surface of a filler in the chamber 132, or even the area of the upper surface 112 that forms an uncovered open hole. These are alternatives are described in detail below.

When a dielectric 116 exists between the FAU 104 and substrate 108, a through-hole 136 through the dielectric 116 may provide a clear path for light between the FAU 104 and the substrate 108. Otherwise, when no dielectric 116 is provided in this area between the FAU 104 and the substrate 108, the vertical optical coupler 134 may be coplanar to an outer contacting surface 138 of the FAU 104, or may extend within the FAU 104. Whether or not the vertical optical coupler 134 extends outward from the upper surface 112 of the substrate 108, and whether or not the dielectric 116 is between the FAU 104 and the substrate 108, the FAU 104 may have its own FAU vertical optical coupler 131 with one of those structures mentioned that could be used for vertical optical coupler 134.

By one form, when the FAU vertical optical coupler 131 engages the vertical optical coupler 134, the two couplers may have complimentary shapes as with a ball and socket connection. The details are provided below. The FAU 104 also may have a mirror to redirect light from the substrate 108 back to horizontal or toward a back of the FAU 104. This may involve the use of a lens 135 to expand or contract the beam size depending on the direction the light is to be propagated, and a waveguide or fiber optic cable 139 to provide or receive light from the vertical optical coupler assembly 120. It should be noted that at least the redirecting element or mirror 130 and the vertical optical coupler 134 form the vertical optical coupler assembly 120, but that any of the optical elements and chambers on the FAU 104 and the substrate 108 related to the vertical or reflected optical path portion in and out of the substrate 108 also may be considered part of the vertical optical coupler assembly 120. Other details are provided below.

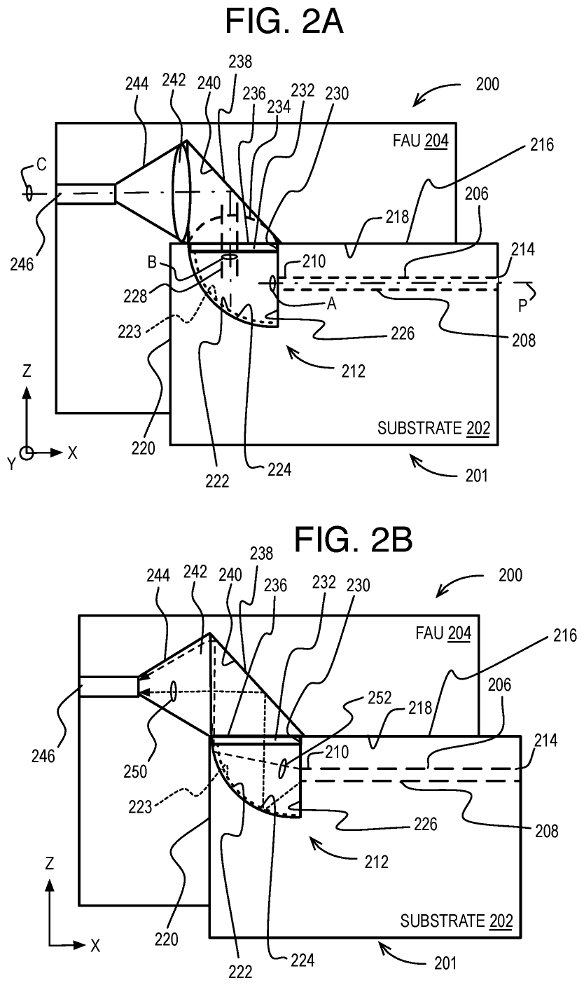

Referring to FIGS. 2A-2B, a package assembly 200 has a package 201 with a substrate 202 engaged directly with an FAU 204 without a dielectric layer between the two structures in this example. The substrate 202 may have an optical path 206 (shown in dashed line) that may or may not be formed or defined by a waveguide 208. The optical path 206 may have a proximal end 210 that either provides light to, or receives light from, an example vertical optical coupler assembly 212. A distal end 214 of the optical path 206 may lead to a PIC, other IC on substrate 202, or other optical element within substrate 202 such that the source or end port of the optical path 206 is within the substrate 202. Otherwise, the optical path 206 may be a part of a complete light path where the optical path 206 simply continues through the substrate 202, and through other optical elements when provided, to end at another surface of the substrate 202. In this latter case, the substrate 202 is merely a through-via for the complete light path. The waveguide 208, when used, may be formed of a transparent core made of laser induced glass of higher refractive index than its surrounding glass. Alternatives, include a polymer based high refractive index core embedded in low refractive index cladding.

The vertical optical coupler assembly 212 provides optical coupling through an upper surface 216 of the substrate 202 and an outer, downward facing surface 218 of the FAU 204 rather than through a side or edge 220 of the substrate 202. It also will be understood that at least some light may be provided between the FAU 204 and substrate 202 via the vertical optical coupler assembly 208, and need not always be the only optical coupling between the FAU 204 and the substrate 202. Thus, conventional edge coupling between the two structures 202 and 204 could be used in addition to the vertical optical coupler assembly 208 when necessary.

The structure of the vertical optical coupler assembly 212 may include a cavity or chamber 222 formed within the bulk material of the substrate 202 and with one wall forming an optical element such as a light redirector or reflector, such as a mirror 224 facing inward in the chamber 216.

An opposite or facing wall 226 facing the mirror 218 receives light from, or provides light to, the proximal end 210 of the optical path 206. The optical path 206, whether formed by the bulk glass of the substrate or a distinct waveguide, may be at least partially linear, entirely linear, or non-linear, as long as the light at the chamber wall 226 is directed from or to the mirror. Specifically, the example optical path 206 here is shown to be linear with an optical axis A that extends toward the mirror 218 at least at the chamber wall 226. It also will be noted that the optical axis A extends toward the edge 220 except that the mirror 224 is placed to intersect the axis A thereby interrupting, blocking, and or redirecting at least part of, or all of, light flow along axis A toward the edge 220. It also will be understood that axis A may define a plane P of the substrate 202 such that optical path 206 is in the plane P and the plane P extends on or through the substrate 202, in contrast to other layers that may be on package assembly 200. Thus, the plane P may be a horizontal plane, but as described above, is not necessarily extending exactly horizontal or 90 degrees from a vertical optical path portion 228 defined by an axis B. By one form, the vertical optical path portion 228 and its axis B at least extends transversely to the plane P.

The chamber 222 may be kept empty (with air or other gas) or may be filled with a transparent or translucent filler material such as a polymer, ester, acrylic, and/or epoxy. The filler material may have a flattened outer surface at the interface between the upper surface 216 and FAU surface 218, and by one form is coplanar with the upper surface 216. The outer surface of the filler then may establish the vertical optical coupler 232 described herein. Otherwise, the filler may be up to a height in the chamber 222 to permit another optical element to be supported at least partially by the filler and to extend in an opening 230 at the upper surface 112.

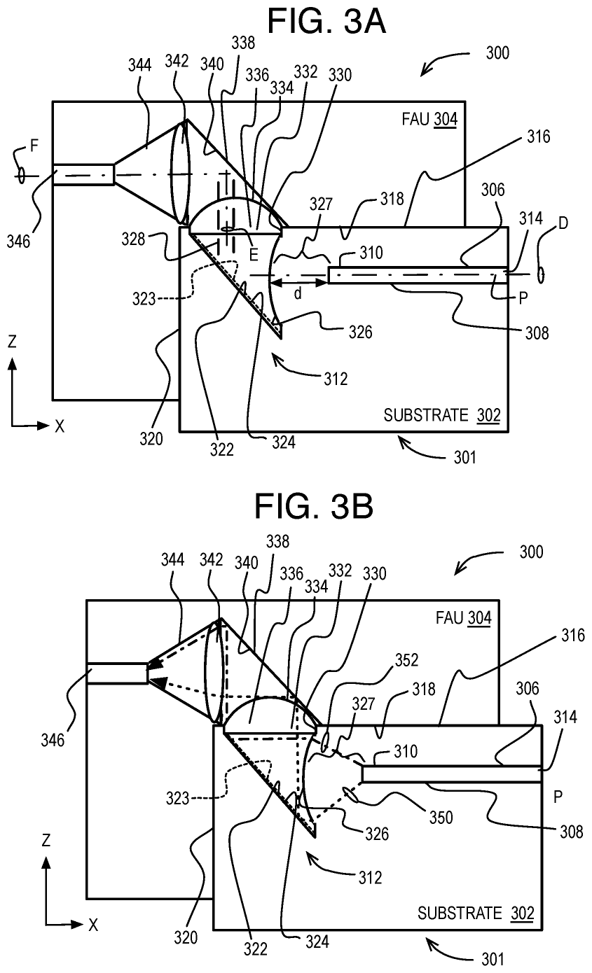

The mirror 224 is curved in this example, and may be a partial cylindrical surface with a horizontal axis of rotation extending parallel to the Y axis, and parallel to both the edge surface 220 and upper surface 218 so that the mirror is shaped to direct light between the vertical optical path portion 228 along axis B and optical path 206 along axis A. Many other curved arrangements could be used for the mirror such as partially hemispherical, or even free form optics. Planar mirror alternatives are provided below with package assembly 300 (FIGS. 3A-3B).

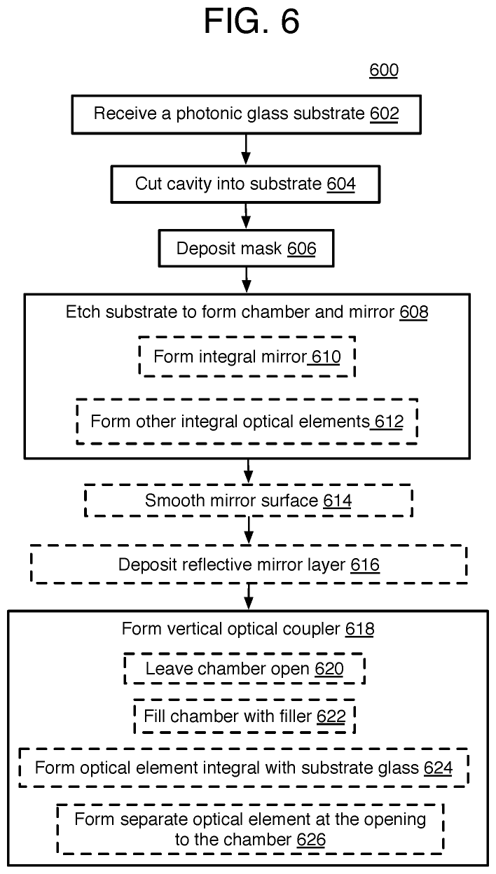

The mirror 224 may be integrally formed from the bulk material of the substrate by etching out the chamber 222 as described with process 600 (FIG. 6), and will reflect light as long as a reflective layer (or surface, coating, or film) 223 covers the mirror glass surface. In this case, it does not matter if the index of refraction of the substance or material in the cavity is higher or lower than the index of the glass forming the mirror. When air is in the cavity, which has a lower index of refraction than the glass mirror, the reflective layer 223 should be used. Also by one approach, the substance or filler in the cavity still should have a smaller index of refraction than the index of refraction of the substrate glass and/or vertical optical coupler 232 when either is being used to form a lens. The reflective layer 223 may comprise a metal, or metal alloy, or other highly reflective material. By one form, the reflective layer 223 may be formed of silver, an alloy of silver, or other reflective metal. Other details are provided below with assembly 300.

The chamber 222 may have the opening 230 formed by the upper surface 216 in this example. A vertical optical coupler 232 is the optical structure at the upper surface 216 or the hole 230 that is used to permit light in or out of the upper surface 216 (or lower surface if used instead) of the substrate 202, and into or out of the FAU 204. By one form, the opening 230 itself, when maintained in an open state to permit light to pass through the hole 230 without any covering, such as by glass, may be considered the vertical optical coupler 232 for the substrate 202. As mentioned above, alternatively the filler may establish the vertical optical coupler 232.

By other forms, the vertical optical coupler 232 may be a transparent or translucent optical element to cover the opening 230 and that may partially or completely enclose the chamber 222. By one form, this may include a generally or substantially flat glass plate. Such a glass plate as coupler 232 may have an outer surface co-planar with the upper surface 216 (or lower surface if used instead) of the substrate 202.

By other forms, the vertical optical coupler 232 may be an optional convex lens, such as convex lens 234 shown in dashed line, and depending on which way the light is being propagated. When the light is outbound from substrate 202 to FAU 204, then the convex lens 234 may act as a collimator to emit outgoing, less divergent light waves into the FAU 204. By one possible example, lens 234 may be concave when used as the vertical optical coupler 232 when the light is incoming to the substrate 202 from the FAU 204 and to abut a convex collimating lens on the FAU 204 in this case. When the mirror 224 is curved as in the example of coupler assembly 212, a lens as the vertical optical coupler 212 may not be needed because the varying angles of points along a curve on the mirror surface, such as for example a quadratic-based curve, should already result in sufficiently vertical parallel (or reduced divergence or beam expansion) light waves moving toward the FAU 204. Other shapes may be used to reduce higher order lens aberrations of a quadratic shaped curve mirror.

The FAU 204 can have the same or similar, but opposite, optical arrangement as on the substrate 202, and as part of the vertical optical coupler assembly 212. Thus, an FAU vertical optical coupler 236 may be the same or similar structure as the vertical optical coupler 234 of the substrate 202, such as open hole, flat surface of a filler, or a flat plate. Alternatively, the FAU vertical optical coupler 236 may be a convex lens, such as a convex lens when the light is propagated from the FAU 204 to the substrate 202. In this case, when the FAU vertical optical coupler extends outward from the FAU bottom surface 218, it may extend into a hole 230 that is the vertical optical coupler 232 on the substrate 108.

Otherwise, the FAU vertical optical coupler 236 may be complimentary to the shape of the vertical optical coupler 232 of the substrate 202. In this case, one coupler may be convex, while the other coupler is concave, and the two couplers 232 and 236 may be arranged to engage or having contacting surfaces, or may be spaced apart, particularly when dielectric 116 extends between the FAU 204 and substrate 202 as described with assembly 100 (FIG. 1).

The FAU 204 also may have a re-director or reflector 238, such as mirror facing inward on a wall of a cavity or chamber 240 as with chamber 222. Here, a collimating or beam reducing lens 242, depending on the direction of light propagation, may form an opposite wall of the chamber 240 and may cover a conical entrance 244 to a FAU optical path 246 with an optical axis C. FAU optical path 246 may be defined by, or be, a waveguide or optical fiber. The axis C of the FAU optical path 246 also may be generally or substantially horizontal, but at least transverse to the vertical optical path portion 228 and axis B.

Referring to FIG. 2B, the vertical optical coupler assembly 212 is shown with example resulting propagating light paths or light rays 250 and 252 rather than showing axes A-C as shown in FIG. 2A for clarity. Here, the light rays 250 and 252 originate from optical path 206 or waveguide 208. Light ray 250 shows the beam expanding once within the chamber 222, and light ray 250 may be a lowest light ray within the chamber 222. The light ray 250 may reflect off of curved mirror 224 (and in turn reflective layer 223) to near vertical, propagates through vertical optical couplers 232 and 236 at the upper surface 216, and to FAU mirror 238. The ray 250 then reflects back to near horizontal and to optical path or waveguide 246.

Similarly, the light ray 252 may be an upper ray within chamber 222 but otherwise has a similar path to that of light ray 250, except higher within the FAU chamber 240 and contraction cone 244. Note that an FAU lens 242 still may be present but is not shown for clarity. The result is a generally, nearly, or substantially horizontal optical path 206 on substrate 202 providing light to the generally, nearly, or substantially horizontal FAU optical path 246 using a vertical optical coupling through the upper surface 216 of the substrate rather than through the side or edge 220 of the substrate. It will be understood the light rays 250 and 252 will work in the opposite direction as well. Also as mentioned, the vertical coupling could be through the lower surface of the substrate instead when desired.

It will be appreciated that when the waveguide 208 is being used, and while the waveguide 208 is shown to extend to surface or wall 226 of the chamber 222, the waveguide could actually be stopped short a distance from the wall 226 when the substrate is formed of transparent or translucent material such as glass. In this case, the light from an end of the waveguide 208 may propagate through the glass of the substrate to the wall 226, thereby continuing optical path 206 all the way to the wall 226. In this example, the light also may expand (the beam may expand) as the light propagates toward the wall 226. This is described in detail with package assembly 300 (FIG. 3).

Referring now to FIG. 3A, a photonic IC package assembly 300 is similar to package assembly 200 such that similar numbered identifiers on package assembly 300 indicate the same or similar component on package assembly 200 unless the differences are explained. Those same or similar components already described above with package assembly 200 need not be described again for package assembly 300. The changes or additions on assembly 300 are described as follows.

Package assembly 300 has a package 301 with a substrate 302 engaging, and optically coupled to, an FAU 304. Assembly 300 has a same or similar light path arrangement except the axes of package assembly 300 are labeled as D-F respectively instead of axes A-C on package assembly 200. One difference here, however, is that a waveguide 308 is shown to have a proximal end 310 that stops short of chamber wall 326 on chamber 322 such that optical path 306 continues to the wall 326 for an area 327 with a distance d through the bulk glass or other transparent or translucent material of the substrate 302 without a waveguide 308. In this case, the distance d at area 327 between the wall 326 and the waveguide 308 may be within about 0.05 to 5 mm depending on factors such as the index of refraction of the substrate glass, the diameter of the light propagating on the optical path 306, and mode size diameter of the waveguide.

A vertical optical coupler assembly 312, similar to assembly 212, may include the mirrors, optical elements, vertical optical couplers, and chambers forming a vertical optical path portion 328 between the FAU 304 and the substrate 302. On the substrate 302, light propagating through area 327 will expand as it extends out of the waveguide 308 and toward the chamber wall 326. In order to control the angles of the light rays or waves as the light traverses the chamber 322 from the wall 326 to the mirror 324, the wall 326 may be shaped to act as, or is, a lens. By the illustrated form, the wall 326 may be curved convexly into the chamber 322 to form a collimating lens so that light rays will be more parallel (less divergent) when propagating from the wall 326 and to the mirror 324. This will result in more uniform parallel light with less beam expansion or divergence being directed from the wall 326, to the mirror 324, and then vertically to the FAU 304. Oppositely, this may cause more light rays from the mirror 324 to merge toward the waveguide 308 after crossing through the convex wall 326. The convex wall 326 may have a partially cylindrical curve or may have a hemispherical segment curve. The mirror 324 in this example is a planar mirror that will result in more expanded light rays than the curved mirror 224 on assembly 200. Thus, the convex collimating lens of wall 326 compensates for this difference. Otherwise, it will be appreciated that the chamber wall 326 may have a number of different shapes, including flat or concave to produce a desired effect on the light rays.

The mirror 324 may be integrally formed of the substrate material or glass. By one form, the mirror 324 may have a reflective layer 323 of metal, or metal alloy, or other reflective material on its front surface, as mentioned above for reflective layer 223, and may be formed of silver, an alloy of silver, or other reflective metal. Also as mentioned, the index of refraction of the substance, such as air, or material, such as filer, in the cavity 322 does not matter as long as the reflective layer 323 is being used, but the index or refraction of the substance or material within the cavity may be smaller than the glass of the lens 326 and vertical optical coupler 332 when such is being used to better ensure sufficient optical propagation.

The planar mirror 324 also may be at an oblique angle relative to, and traversing, axis D of the optical path 306 and waveguide 308 as well as axis E of the vertical optical path portion 328. The angle may be any desired angle to form a vertical optical path portion or vertical optical path component sufficient to propagate light between the FAU 304 and substrate 302 through the upper (or lower) surface 316 of the substrate rather than the edge 320 of the substrate 302.

As with assembly 212, a vertical optical coupler 332 of the substrate 302 may be a hole 330 to the chamber 322 and formed at the upper surface 316 of the substrate 302, filler material filling the chamber 322 and hole 330, or an optical element such as a flat glass plate at or covering the hole 330. In the illustrated example, the vertical optical coupler 332 of the substrate may be a convex lens or collimator lens 334, while the FAU vertical optical coupler 336 may be a hole into a chamber 340 on the FAU 304. Otherwise the description of the parts of the vertical optical coupler assembly 312 is the same as that already described above for assembly 212 (FIG. 2).

Referring to FIG. 3B, example light rays 350 and 352 show example light flow through the vertical optical coupler assembly 312. Light ray 350 is shown as a lower expanding beam light ray that is straightened by the convex lens 326 before reflecting off of the mirror 324 and to vertical, through vertical optical couplers 332 and 336 and to FAU mirror 338. The light ray 350 is then reflected again back to generally or substantially horizontal, through collimator lens 342, and then contracted inward to waveguide or optic fiber cable 346.

Likewise, light ray 352 is an upper beam expansion ray from waveguide 308, straightened by lens 326, redirected to generally, nearly, or substantially vertical by mirror 324, through vertical optical couplers 332 and 336, re-directed again to generally, nearly, or substantially horizontal by FAU mirror 338, and through lens 342 to waveguide or fiber optic cable 346. The light rays may work in the opposite direction as well.

It also will be appreciated that the package assembly 200 or 300 may have multiple vertical optical coupler assemblies forming an array of the vertical optical couplers on the upper surface 216 or 316 (and/or lower surfaces) of the substrate 202 or 302. Each or individual vertical optical coupler assembly 212 or 312 forming a vertical optical coupler 232 or 332 in the array on the substrate may have its own optical paths, optical elements and so forth as described with a single vertical optical coupler assembly 212 or 312. The details of the array layout are provided below with package assembly 500 (FIG. 5).

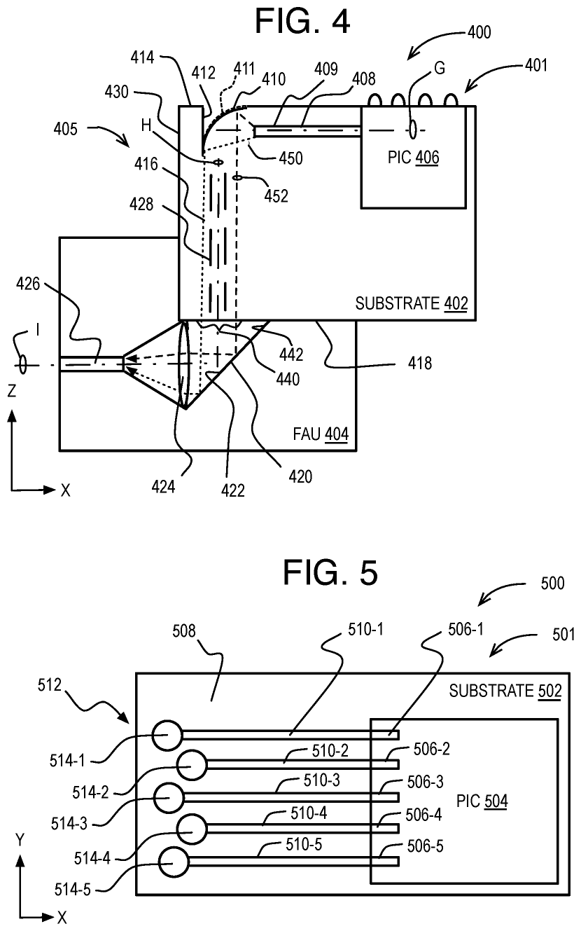

Referring for now to FIG. 4, an alternative package assembly 400 has a package 401 with a substrate 402 and an FAU 404 engaging, and optically coupled to, the substrate 402 through a vertical optical coupler assembly 405. As with coupler assemblies 212 and 312 described above, vertical optical coupler assembly 405 may include any of the optical elements, chambers, vertical optical couplers, and mirrors forming a vertical optical path portion 428 and on both the substrate 402 and FAU 404. Unlike the vertical optical coupler assemblies 212 and 312, however, in the example of coupler assembly 405, a cavity or chamber 412 is behind a mirror 410 rather than in front of the mirror 410, and the mirror 410 is formed at or near the upper surface 414 of the substrate 402 while the vertical optical couplers of the FAU and substrate are at a lower or bottom surface 418 of the substrate 402.

Particularly, a PIC 406 may be on, or embedded within, a cavity on the substrate 402. In this example, the PIC 406 may be exposed at the upper surface 414 of the substrate 402, and the PIC 406 may have solder balls or other connectors to support and couple to other IC devices, dies, chips, or other integrated circuit components to be supported by the substrate 402 on the package 401. The PIC 406 may have optical or electrical components or circuitry as described above and that may include an optical port or optical source having an optical axis G along an optical path 408 or waveguide 409 (and in turn in a plane of the substrate), and where the axis G extends in a direction toward mirror 410 and side or edge 430 of the substrate 402.

As with substrate 302, the waveguide 409 here also may stop short from a cavity or chamber 412, except here stopping short from the mirror 410, and at a distance d from the mirror as described above with distance d of area 327. Light emitted from the waveguide 409 will expand as it propagates to the mirror 410, or oppositely, light from the mirror 409 will contract as the light propagates toward the waveguide 409. The mirror 410 is formed on one wall of cavity 412 which may be open to the upper surface 414 on the substrate 402, and in this example, the mirror 410 faces outward from the cavity 412.

By one alternative, the cavity 412 may be left empty, or more precisely, filled with air or another gas. Otherwise, the cavity 412 may be filled with a filler material such as a polymer or metal. A reflective material may be used as the filler in this example to provide a backing layer to the mirror 410 to make the mirror 410 more reflective. Alternatively, a reflective layer 411 in cavity 412 and positioned against a back of the mirror 410 may be used as a backing layer to mirror 410, whether or not the rest of the cavity 412 is filled with a filler or not. In either case, the reflective material or backing layer 411 may be a reflective metal such as silver, silver alloy, other metal alloy, or other reflective material as described above with reflective layers 223 (FIG. 2) and 323 (FIG. 3). Here, however, the reflective layer 411 may not be needed when the index of refraction of the glass of the substrate 402 that receives the incident light rays propagating towards the mirror 410 is higher than the index of refraction of the substance or material in the cavity 412, such as air or other filler, behind the mirror. The use of the reflective layer 411 anyway may allow the substance or material in the cavity 412 to be any index of refraction, even higher than the index of refraction of the substrate glass.

The mirror 410 is shown to be curved in this example, whether partially hemispheric or cylindrical, but could be a planar mirror or other shape instead. If the mirror 410 is to be planar, other collimating elements should be used to generate more parallel light waves or rays (or in other words, less divergent with a smaller beam) being propagated vertically, and here downward. A vertical optical light path 428, whether being reflected light initially from the optical path 408, or light initially from the FAU 404 and propagating toward the mirror 410, may have a vertical optical axis H transverse to optical axes G and I (and plane P when axis G is in plane P of the substrate 402). The vertical optical path or path portion 428 may extend between the mirror 410 and the lower surface 418 of the substrate 402. Alternatively, a waveguide also could be used.

As with the other vertical optical path portions, the vertical optical path 428 here also may be generally, nearly or substantially vertical as long as a portion of the vertical optical path 428 is transverse to optical paths 408 and 426 and extends toward the upper or lower surface 414 or 418 of the substrate 402.

The vertical optical path 428 extends to or from a vertical optical coupler 440 on the lower surface 418 of the substrate 402. In this example, the vertical optical coupler 440 is a region of the lower surface 418 that permits light from vertical optical path 428 to project (or propagate or flow) out of the substrate 402 at the region. Thus, the region 440 may have or be a flat glass surface formed of the bulk glass of the substrate and co-planar with, and part of or homogenous with, the remainder of the lower surface 418 of the substrate 402. It will be understood that instead, the vertical optical coupler 440 could be a number of different structures as described with some of the other vertical optical couplers herein. Thus, instead, the vertical optical coupler 440 could be a hole or opening to a cavity in the substrate 402, a filler in such a cavity, optical elements such as a concave or convex lens, or flat glass plate, any of which is either integrally formed with the bulk glass of the substrate 402 or formed separately and mounted onto the substrate 402 as described above with the other coupler assemblies. When multiple vertical optical coupler assemblies are present on a single substrate, each coupler assembly may have its own glass surface region as the vertical optical coupler 440.

The FAU 404 has the same or similar vertical optical coupler assembly 405 structure as that already described with coupler assemblies 212 and 312. The FAU vertical optical coupler 442 may be an opening to an FAU cavity or chamber 422 with an FAU mirror 420 that receives light from the vertical optical coupler 440 on the substrate 402. Rather than an opening as the FAU vertical optical coupler 442, other optical elements or structures can be used instead as described above with coupler assemblies 212 and 312. The mirror 420 redirects the light from or to the vertical optical path 428 back to or from generally, nearly, or substantially horizontal as shown by optical axis I of FAU optical path 426.

It also will be appreciated that both optical path 408 and vertical optical path 428 can propagate light through bulk glass of substrate 402 without a waveguide. In this example case, no waveguide is used on the package assembly 400 for the vertical optical coupling at all. The light will propagate through the optical paths 408 and 428 as long as the distance between optical elements is carefully controlled. Thus, the distance of optical path 408 could be provided without a waveguide as long as the distance from the source (or port) on the PIC 406, or another other source or port on the substrate, to the mirror 410 is carefully controlled. Likewise, the vertical optical path distance from mirror 410 to or from the lower surface 418 of the substrate 402 should be carefully controlled to transmit light without a waveguide. This is the same for any of the substrates 108, 202, 302, 702 disclosed herein.

By one form, the light propagation distance that can be achieved along the optical paths 408 or 428, as with the non-waveguide distance d in area 327 (FIG. 3), may depend on the optics used including the diameter of the light on the optical paths, indices of refraction of the glass and other material, such as air or filler, and whether or not one or more collimators are used to control the divergence of the light propagated onto the optical paths to make the light more parallel (or more precisely, less divergent or to narrow the beam of the light). In the current example, the propagation distance on the optical paths 408 or 428 can reach about 100-200 microns or up to 200 microns even though a collimator is not used by the mirror to control the divergence of the light rays. This is due to using a typical lens at the light output at the PIC, and then due to the collimating effect of the mirror itself. Otherwise, from the end 409 of a waveguide 408 or from an end of a laser at the PIC 406 on substrate 402 without any other collimating lens or beam-controlling optical element, the maximum useful light propagation may be less than 10 microns.

When a collimator is being used to control the light divergence and beam width of the light waves or rays, then the propagation distance in air and/or glass depends, at least in part, on the diameter of the expansion. For example, when the light is collimated and has parallel waves, about a 50 micron diameter beam can propagate about 0.5 to 1 mm through the substrate glass without a waveguide, or through air and glass when the chamber is in front of the mirror as in coupler assemblies 212 and 312. Similarly, about a 100 micron diameter beam should result in up to about 5 mm propagation distance, while about a 200 micron diameter beam may result in up to 20 mm propagation distance. This applies to any of the optical path axes G-I on package 400, any of the other optical paths on the other assemblies, or portions thereof, where ever a waveguide is not being used in the substrate glass (or on a glass FAU when desired).

By alternative approaches, the vertical optical coupler assembly may have other solutions to generate a vertical light path portion rather than with two mirrors, such as a spot size converter plus a waveguide, or Gradient-Index (GRIN) Lenses like element, and so forth.

Referring to FIG. 5, a package assembly 500 may be, or may be similar to, any of the package assemblies disclosed herein. Package assembly 500 may have a package 501 with a substrate 502. In this example, substrate 502 may have or support a photonic IC (PIC) 504 with optical components 506-1 to 506-5 that are either optical sources that generate and emit light, such as lasers, or optical ports that receive light.

Particularly, each optical component 506-1 to 506-5 may have an optical path 510-1 to 510-5 that optically couples the optical components 506-1 to 506-5 respectively to vertical optical couplers 514-1 to 514-5 respectively. The optical paths 510-1 to 510-5 may be generally or substantially parallel, although alternatively some slow bending (with large radius of curvature) with some light energy loss may be established in parallel or individually along any of the optical paths 510-1 to 510-5 if desired, such as when routing the optical paths through waveguides.

The vertical optical couplers 514-1 to 514-5 may collectively form an array 512, each vertical optical coupler 514-1 to 514-5 being part of its own vertical optical coupler assembly as described herein. Five such couplers 514-1 to 514-5 are shown simply as a random example and may be more or less than five. The array 512 of the vertical optical couplers 514-1 to 514-5 may be on either a lower surface or upper surface 508 of the substrate 502. The actual layout of the array (or matrix) 512 can be adaptable as desired, and may be limited by how the waveguides and optical paths can be routed and terminated on the substrate including the desired fiber or waveguide density needed on the FAU, and in turn the substrate 502. By one example, the array 512 may be in a staggered pattern, but could be a square or matrix of rows and columns, or any other desired pattern.

As mentioned with the other assemblies, the optical paths 510-1 to 510-5 may be generated without the use of waveguides as long as the substrate 502 is made of glass sufficient to transmit light as described herein. To accomplish the elimination of the waveguides at least for horizontal optical paths 510-1 to 510-5, the PIC's individual light input ports (or optical sources), and in turn the resulting optical pathways should be separated from each other enough (from edge to edge) in a range of about 20-200 μm, depending on the mirror and/or lens arrangement. Specifically, the spacing should be larger than the targeted mode size reaching 514-1 to 514-5.

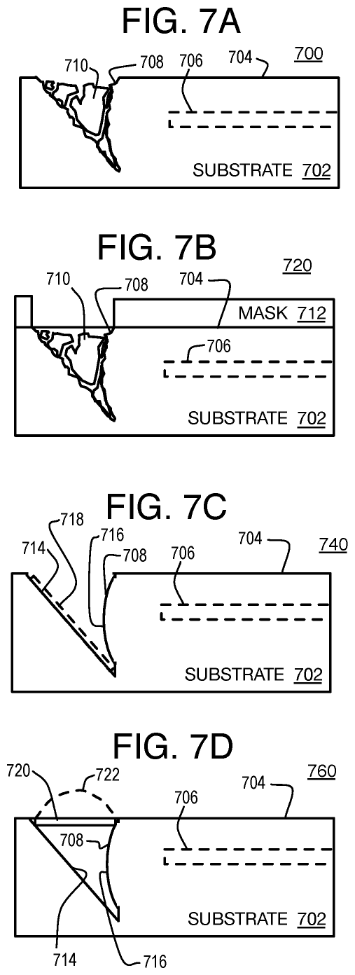

Referring to FIG. 6, an example method of manufacturing a photonic package substrate with a vertical optical coupler is performed according to at least one of the implementations disclosed herein and is described with example manufacturing stages of FIGS. 7A-7D. Process 600 includes operations 602 to 626 generally numbered evenly, and electronic systems, devices, and/or package assemblies 100, 200, 300, 400, 500, and 700 of FIGS. 1-5 and 7A-7D may be referred to herein where appropriate.

Process 600 may include “receive a photonic glass substrate” 602, where a glass substrate is manufactured by known techniques. Particularly, this may include first forming the a wafer sized substrate on a carrier by known wafer or substrate manufacturing processes. This operation also may include embedding PICs or other IC components within the substrate when such components are being used. By one form, this operation may or may not include singulation. Thus, the formation of the vertical optical coupling components may be generated either before or after singulation of the substrates from a wafer. By one form, the operations performed herein for process 600 are before dielectric layers are formed on the upper and lower surfaces of the substrate.

This operation 602 also may include embedding waveguides, when being used, within the substrate, and the waveguides may be positioned by known techniques such as using V-grooves to place the waveguides or in situ formation through laser scribing.

Process 600 may include “cut cavity into substrate” 604. Laser cutting tools may be used to cut a cavity through the substrate upper or lower surface as desired, and to loosen glass pieces that can be more easily removed from the cavity after etching. Such cutting may be performed by focused femtosecond laser radiation and selective chemical etching.

Referring to FIG. 7A, a package substrate manufacturing stage 700 shows a substrate 702 with an upper surface 704 and an optional embedded waveguide 706 that may form an optical path and lead to a PIC, other optical components, or another outer surface of the substrate 702. Substrate 702 has a cavity 708 cut by using the laser mentioned or other technique. The result of using a laser may be many glass pieces that are at least partially separated from the cavity walls but still within the cavity, or even free floating glass pieces 710 that can be removed during the later etching process. The resulting cavity walls may have the shape of the mirror and other optical elements such as the convex collimating lens on the cavity wall opposite the mirror wall when being used. However, further treatment of the cavity wall surfaces still may be desired to further smooth the surfaces.

Process 600 may include “deposit mask”, 606 and to begin lithography etching. The mask may be deposited by chemical vapor deposition (CVD) or other liquid coating, and may be a polymer or removable inorganic material. Once the mask is deposited, the mask above the cavity 708 may be removed to make the cavity accessible for etching. A package substrate manufacturing stage 720 (FIG. 7B) shows this stage in the process 600.

Process 600 may include “etch substrate to form chamber and mirror” 608. Once the upper (or lower) surface 704 of the substrate 702 has been masked exteriorly of the cavity 708, then etching can be performed to remove the glass debris in the cavity 708 and to more precisely shape the mirror, and collimating lens if present. Thus, the etching may include simply “popping off” the loosely attached and floating glass pieces remaining in the cavity 708, which may increase the speed of the etch process. The etching also may include etching the layers near the cavity walls to more precisely shape or smooth a layer of the cavity defining the mirror and lens surfaces. By one form, the etching is performed by HF solution or NaOH solution.

This operation 608 may include “form integral mirror” 610, and “form other integral optical elements” 612. Thus, when the substrate is formed of glass, then etching the mirror and lenses in addition to later optional surface shaping treatments if desired, is all that may be needed to have a mirror that sufficiently reflects light to a vertical optical path.

Whether or not the glass is polished, process 600 optionally may include “deposit reflective mirror layer” 616 and for the reasons explained above. A metal or metal alloy layer, such as silver or silver alloy, may be deposited on the mirror surface for increased reflectivity. The deposition techniques that can be used include CVD. This should complete the cavity walls, and as shown on package substrate manufacturing stage 740 (FIG. 7C), with a mirror 714 with or without a reflective layer 718, and a curved lens 716. It will be understood that many of the cavity and mirror arrangements described above can be formed with the same process, including with different shapes for mirror 714 and lens 716, if present at all.

Process 600 optionally may include “form vertical optical coupler” 618 and of the substrate. As mentioned, this may include a number of different alternative structures as follows.

By one option, operation 618 optionally may include “leave chamber open” 620, where the chamber is kept empty, such as with air, and the opening of the chamber at the upper surface of the substrate is open without a filler or covering lens that is fixed to the substrate. The FAU may cover the opening to the chamber on the substrate with hardened filler in its own cavity, a flat glass plate, or its own optical element, such as a convex lens or bump, that extends into the opening of the chamber on the substrate.

By an alternative option, operation 618 may include “fill chamber with filler” 622, where a transparent or translucent filler such as a polymer, ester, acrylic, or epoxy with an index of refraction different than the glass of the mirror may be deposited into the chamber. By one form, the filler has an index of refraction lower than the glass of the mirror when the chamber is behind the mirror, but otherwise the index of refraction does not matter as long as the mirror has a reflective layer or coating on the front mirror surface. When the mirror is curved, the index of refraction is not limited as long as the material or substance in the cavity is sufficiently transparent or translucent and as long as the curved mirror is covered with a highly reflective coating or layer, such as silver or silver alloy. The filler may be filled to a level in the chamber to support an optical element such a convex lens in the opening to the chamber, or may be filled to the upper surface of the substrate and in the opening to the chamber. Thus, the filler itself may be coplanar with the upper (or lower) surface of the substrate and may be the vertical optical coupler of the substrate.

By another alternative, operation 618 may include “form optical element integral with substrate glass” 624, where here a concave or convex lens, or glass plate may be formed integrally with the glass near the opening of the chamber at the upper surface of the substrate. This can be accomplished whether or not a filler is placed in the chamber next to the mirror. This may involve lithography.

By yet another option, operation 618 may include “form separate optical element at the opening to the chamber” 626. Here, the vertical optical coupler, such as a convex or concave lens, or glass plate, is formed separately and placed over the opening to the chamber. This may be performed by active alignment processes.

Referring to FIG. 7D, a package substrate manufacturing stage 760 shows a flat glass plate 720 covering the cavity 708, but could alternatively be a bump-shaped convex collimating lens 722 or other optical element instead. Thereafter, the dielectric layers on the substrate may be completed, and other IC devices, dies, chips, and components, as well as the FAU then may be mounted onto the substrate, and the substrate may be mounted onto a PCB or other host or carrier to complete the package.

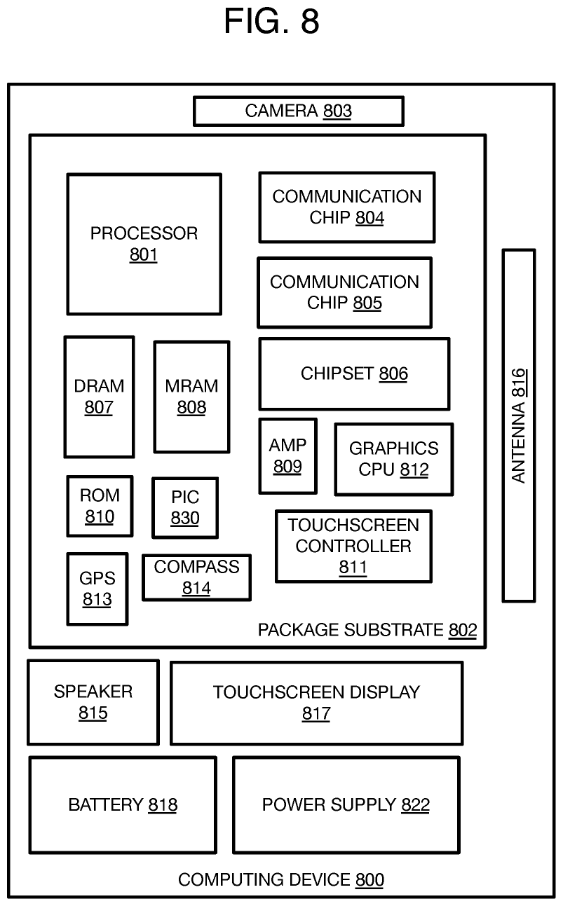

Referring to FIG. 8, a functional block diagram of an electronic computing device 800 is provided in accordance with at least one implementation herein. Device 800 further includes a package substrate 802 hosting a number of components, such as, but not limited to, a processor 801 (e.g., an applications processor). In implementations, device 800 also may include a PIC 830 on the substrate 802 and an FAU socket as described elsewhere herein. Processor 801 may be physically and/or electrically coupled to package substrate 802. In some examples, processor 801 is within a composite IC chip structure including a chiplet bonded to a host IC chip, for example. Processor 801 may be implemented with circuitry in either or both of the host IC chip and chiplet. In general, the term “processor” or “microprocessor” may refer to any device or portion of a device that processes electronic data from registers and/or memory to transform that electronic data into other electronic data that may be further stored in registers and/or memory.

In various examples, one or more communication chips 804 and 805 also may be physically and/or electrically coupled to the package substrate 802. In further implementations, communication chips 804 and 805 may be part of processor 801. Depending on its applications, computing device 800 may include other components that may or may not be physically and electrically coupled to package substrate 802. These other components include, but are not limited to, volatile memory (e.g., DRAM 807), non-volatile memory (e.g., ROM 810), flash memory (e.g., NAND or NOR), magnetic memory (MRAM 808), a graphics processor (CPU) 812, a digital signal processor, a crypto processor, a chipset 806, an antenna 816, touchscreen display 817, touchscreen controller 811, battery unit 818, audio codec, video codec, power amplifier 809, global positioning system (GPS) device 813, compass 814, accelerometer, gyroscope, speaker 815, camera 803, and mass storage device (such as hard disk drive, solid-state drive (SSD), compact disk (CD), digital versatile disk (DVD), and so forth), and a power supply unit 822, or the like. In some exemplary implementations, at two of the functional blocks noted above are within a composite IC chip structure including a chiplet bonded to a host IC chip, for example as described elsewhere herein. For example, processor 801 be implemented with circuitry in a first of the host IC chip and chiplet, and an electronic memory (e.g., MRAM 808 or DRAM 807) may be implemented with circuitry in a second of the host IC chip and chiplet.

Communication chips 804 and 805 may enable wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some implementations they might not. Communication chips 804 and 805 may implement any of a number of wireless standards or protocols. For example, a first communication chip 804 may be dedicated to shorter-range wireless communications, such as Wi-Fi and Bluetooth, and a second communication chip 805 may be dedicated to longer-range wireless communications such as GPS, EDGE, GPRS, CDMA, WiMAX, LTE, Ev-DO, and others.

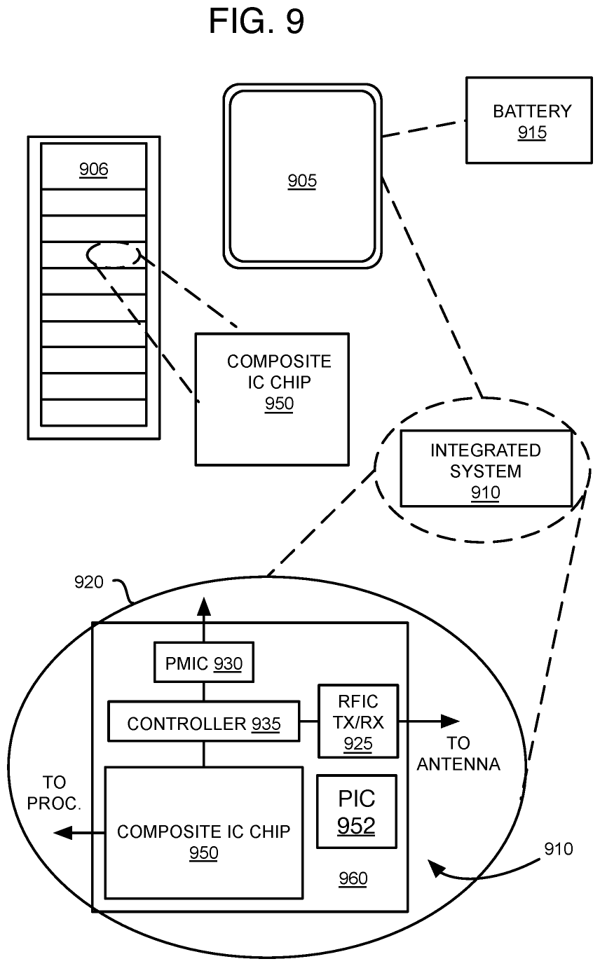

Referring to FIG. 9, a mobile computing platform 905 and a data server machine 906 employing an IC device comprises at least one PIC 952 included in a photonic package substrate 960 as described elsewhere herein. Computing device 800 may be found inside platform 905 or server machine 906, for example. The server machine 906 may be any commercial server, for example including any number of high-performance computing platforms disposed within a rack and networked together for electronic data processing, which in the exemplary implementation includes at least one PIC 960 included in a package, for example as described elsewhere herein, and may include a chiplet bonded to a host IC chip or the package substrate. The mobile computing platform 905 may be any portable device configured for each of electronic data display, electronic data processing, wireless electronic data transmission, or the like. For example, the mobile computing platform 905 may be any of a tablet, a smart phone, laptop computer, etc., and may include a display screen (e.g., a capacitive, inductive, resistive, or optical touchscreen), a chip-level or package-level integrated system 910, and a battery 915.

Whether disposed within the integrated system 910 illustrated in the expanded view 920, or as a stand-alone package within the server machine 906, composite IC chip 950 may include a chiplet bonded to a host IC chip, for example as described elsewhere herein. Composite IC chip 950 may be further coupled to a host photonic substrate 960 comprising a PIC 960, an FAU socket, and one or more vertical optical coupler assembly as described elsewhere herein, one or more of a power management integrated circuit (PMIC) 930, RF (wireless) integrated circuit (RFIC) 925 including a wideband RF (wireless) transmitter and/or receiver (TX/RX) (e.g., including a digital baseband and an analog front end module further comprises a power amplifier on a transmit path and a low noise amplifier on a receive path), and a controller 935. PMIC 930 may perform battery power regulation, DC-to-DC conversion, etc., and so has an input coupled to battery 915 and with an output providing a current supply to other functional modules. As further illustrated, in the exemplary implementation, RFIC 925 has an output coupled to an antenna (not shown) to implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 4G, and beyond.

It is understood that the subject matter of the present description is not necessarily limited to specific applications illustrated in FIGS. 1-9. The subject matter may be applied to other microelectronic photonic devices and assembly applications, as well as any appropriate electronic application, as will be understood to those skilled in the art.

The following examples pertain to further implementations. Specifics in the examples may be used anywhere in one or more implementations.

In example 1: a device comprises an integrated circuit (IC) package substrate comprising: an upper surface; a lower surface opposite the upper surface; an outer side surface extending between the upper surface and the lower surface; at least one optical path in a plane of the IC package substrate; and at least one vertical optical coupler at the upper or lower surface of the IC package substrate being optically coupled to the optical path.

In example 2: the device of example 1, comprising an array of the vertical optical couplers at the upper surface, lower surface, or both, each being aligned with a different one of the optical paths.

In example 3: the device of example 1 or 2, wherein each optical path comprises an optical waveguide.

In example 4: the device of example 1, 2, or 3, wherein the vertical optical coupler comprises a convex or concave lens at the upper surface, lower surface, or both.

In example 5: the device of example 4, wherein the substrate comprises glass, and wherein the lens comprises the glass.

In example 6: the device of any one of examples 1 to 5, wherein the substrate comprises a mirror disposed to redirect light from the optical path and to the at least one vertical optical coupler.

In example 7: the device of any one of examples 1 to 6, wherein the substrate comprises a chamber of a different material than a material within the substrate, a mirror on a surface of the chamber, and an opening to the chamber at the upper surface, lower surface, or both.

In example 8: the device of any one of examples 1 to 3 and 6 to 7, wherein the substrate comprises a chamber of a different material than a material within the substrate, a mirror on a surface of the chamber, and an opening to the chamber at the upper surface, lower surface, or both, and wherein the vertical optical coupler is a portion of the upper surface, lower surface, or both and comprises the opening to the chamber without an optical element of the substrate covering the opening.

In example 9: the device of example 7, wherein the vertical optical coupler is a glass element covering the opening.

In example 10: the device of any one of examples 1 to 9, wherein the optical path extends generally horizontal on the plane and generally parallel to the upper surface, lower surface, or both, and wherein the vertical optical coupler has an optical axis transverse to the plane.

In example 11: A system comprises an integrated circuit (IC) package substrate with a recess; and a photonic integrated circuit (PIC) within the recess and having an optical source or an optical port, the IC package substrate comprising: at least one optical path extending from the optical port or optical source, and at least one vertical optical coupler at an upper or lower surface of the substrate and being optically coupled to the optical port or optical source through the optical path.

In example 12: the system of example 11, comprising a fiber array unit (FAU) optically coupled to the substrate and having at least one FAU vertical optical coupler aligned with the at least one vertical optical coupler of the substrate.

In example 13: the system of example 12, wherein the optical path is horizontal, and wherein the substrate comprises a first mirror redirecting light of the optical path to a vertical optical path extending through the FAU and substrate vertical couplers and to a second mirror at the FAU.

In example 14: an integrated circuit (IC) photonic package substrate comprises a glass body with an upper surface and a lower surface; at least one optical path within the glass body and extending generally parallel to the upper or lower surface; at least one mirror intersecting the optical path within the substrate and disposed transversely to the optical path; and at least one vertical optical coupler at the upper or lower surface and optically coupled to the at least one mirror.

In example 15: the substrate of example 14, wherein the mirror comprises a surface of at least one of a reflective metal, metal alloy, silver, and silver alloy.

In example 16: the substrate of example 14 or 15, comprising a vertical waveguide extending between the mirror and the upper surface or lower surface.

In example 17: the substrate of example 14 or 15, wherein the substrate comprises a reflected vertical optical pathway extending from proximal to the mirror to the upper or lower surface, wherein the substrate is a glass substrate, and wherein the reflected vertical optical pathway is without a vertical waveguide between the mirror and upper or lower surface.

In example 18: the substrate of any one of examples 14 to 17, comprising a chamber with a surface, and a mirror on the surface, and wherein the chamber is behind or in front of the mirror, wherein the front of the mirror faces the optical path, and wherein the chamber holds a material with a different index of refraction than the index of refraction of the mirror.

In example 19: the substrate of example 18, wherein the mirror is disposed nearer the upper surface or lower surface that is opposite the upper surface or lower surface nearest the at least one vertical optical coupler.

In example 20: the substrate of example 18 wherein the chamber comprises a collimator wall opposite a mirror.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed is:

1. A device, comprising:
an integrated circuit (IC) package substrate comprising:
an upper surface;
a lower surface opposite the upper surface;
an outer side surface extending between the upper surface and the lower surface;
at least one optical path in a plane of the IC package substrate; and
at least one vertical optical coupler at the upper or lower surface of the IC package substrate being optically coupled to the optical path.

2. The device of claim 1, comprising an array of the vertical optical couplers at the upper surface, lower surface, or both, each being aligned with a different one of the optical paths.

3. The device of claim 1, wherein each optical path comprises an optical waveguide.

4. The device of claim 1, wherein the vertical optical coupler comprises a convex or concave lens at the upper surface, lower surface, or both.

5. The device of claim 4, wherein the substrate comprises glass, and wherein the lens comprises the glass.

6. The device of claim 1, wherein the substrate comprises a mirror disposed to redirect light from the optical path and to the at least one vertical optical coupler.

7. The device of claim 1, wherein the substrate comprises a chamber of a different material than a material within the substrate, a mirror on a surface of the chamber, and an opening to the chamber at the upper surface, lower surface, or both.

8. The device of claim 7, wherein the vertical optical coupler is a portion of the upper surface, lower surface, or both and comprises the opening to the chamber without an optical element of the substrate covering the opening.

9. The device of claim 7, wherein the vertical optical coupler is a glass element covering the opening.

10. The device of claim 1, wherein the optical path extends generally horizontal on the plane and generally parallel to the upper surface, lower surface, or both, and wherein the vertical optical coupler has an optical axis transverse to the plane.

11. A system, comprising:
an integrated circuit (IC) package substrate with a recess; and
a photonic integrated circuit (PIC) within the recess and having an optical source or an optical port, the IC package substrate comprising:
at least one optical path extending from the optical port or optical source, and
at least one vertical optical coupler at an upper or lower surface of the substrate and being optically coupled to the optical port or optical source through the optical path.

12. The system of claim 11, comprising a fiber array unit (FAU) optically coupled to the substrate and having at least one FAU vertical optical coupler aligned with the at least one vertical optical coupler of the substrate.

13. The system of claim 12 wherein the optical path is horizontal, and wherein the substrate comprises a first mirror redirecting light of the optical path to a vertical optical path extending through the FAU and substrate vertical couplers and to a second mirror at the FAU.

14. An integrated circuit (IC) photonic package substrate, comprising:
a glass body with an upper surface and a lower surface;
at least one optical path within the glass body and extending generally parallel to the upper or lower surface;
at least one mirror intersecting the optical path within the substrate and disposed transversely to the optical path; and
at least one vertical optical coupler at the upper or lower surface and optically coupled to the at least one mirror.

15. The substrate of claim 14, wherein the mirror comprises a surface of at least one of a reflective metal, metal alloy, silver, and silver alloy.

16. The substrate of claim 14, comprising a vertical waveguide extending between the mirror and the upper surface or lower surface.

17. The substrate of claim 14, wherein the substrate comprises a reflected vertical optical pathway extending from proximal to the mirror to the upper or lower surface, wherein the substrate is a glass substrate, and wherein the reflected vertical optical pathway is without a vertical waveguide between the mirror and upper or lower surface.

18. The substrate of claim 14, comprising a chamber with a surface, and a mirror on the surface, and wherein the chamber is behind or in front of the mirror, wherein the front of the mirror faces the optical path, and wherein the chamber holds a material with a different index of refraction than the index of refraction of the mirror.

19. The substrate of claim 18, wherein the mirror is disposed nearer the upper surface or lower surface that is opposite the upper surface or lower surface nearest the at least one vertical optical coupler.

20. The substrate of claim 18 wherein the chamber comprises a collimator wall opposite a mirror.
